(19) United States
(12) Patent Application Publication
(10) Pub. No.: US 2004/0206156 A1
(43) Pub. Date: Oct. 21, 2004

(54) Rebound tester

(75) Inventor: Keith E. Barr, Los Angeles, CA (US)

Correspondence Address: MORRISON & FOERSTER LLP, 755 PAGE MILL RD, PALO ALTO, CA, 94304-1018, US

(73) Assignee: Exelys LLC, Los Angeles, CA

(21) Appl. No.: 10/821,416

(22) Filed: Apr. 9, 2004

Related U.S. Application Data
(60) Provisional application No. 60/463,290, filed on Apr. 15, 2003.

(51) Int. Cl. G01N 3/30

(52) U.S. Cl. 73/12.01

(57) ABSTRACT

A device for testing the rebound quality of a golf ball is described. The device includes a substrate of hard, dense material with a level, flat upper surface, the substrate being attached to an accelerometer that is capable of sensing the impact of a golf ball dropped onto the substrate's upper surface. In turn, the accelerometer is connected to a pulse period measuring module capable of determining the period of time between successive impacts as the golf ball freely and repeatedly bounces against the substrate. Further, a computational module capable of determining from three or more successive bounces the mechanical loss the golf ball experiences on each bounce. Three successive impacts against the substrate result in two time period measurements. The first time period is that which elapses between the first and second impacts and the second time period is that which elapses between the second and third impacts. Each respective period is proportional to the square root of the energy imparted to the ball on its previous impact. The simple ratio of the squares of the two measured time periods results in an accurate measurement of ball rebound quality, which can be displayed as a percentage, a value from 0 to 1, or any arbitrary scale, on an attached LCD display. Finally, as the hard, dense substrate will absorb a small portion of the impacting ball's energy, a computation can be made to make slight numerical corrections prior to the display of results. In the case of golf balls, the exact mass of the ball can be carefully controlled by the manufacturer to a universal standard, so that such corrections, although small, can deliver excellent accuracy. In use, the user simply drops a golf ball onto the center of the substrate and allows it to bounce at least three times. The time periods are calculated, corrections are made, and the results are promptly displayed.

### CROSS-REFERENCE TO RELATED APPLICATIONS

This application claims the benefit of U.S. Provisional Application No. 60/463,290, filed Apr. 14, 2003, the disclosure of which is incorporated herein in its entirety as if fully set forth below.

### BACKGROUND

The game of golf has been very much improved over the years by the development of specialty materials for the composition and manufacture of golf balls. Such new materials add useful properties such as increased toughness so that the golf balls may last longer, and high rebound polymers that allow the ball to fly farther for a given golf club impact.

The property of rebound is traditionally determined from the raw material, where a ½ thick layer of material to be tested is laid onto a hard, dense surface. A steel ball is dropped onto the material from a precise height, and the height of rebound of the steel ball is measured. Although this may be useful in a laboratory setting, where component materials in a flat form are available, it is an inappropriate measurement technique for finished golf balls.

A simple method of measuring the rebound of a golf ball is to drop a golf ball onto a hard, dense surface from a prescribed height, and measure how high the ball rebounds, as a proportion of the prescribed dropping height. Unfortunately, although it is a relatively easy matter to drop the ball from a prescribed height, special equipment is required to accurately determine the maximum height of the ball when it rebounds off the surface. Such a method, although usable, is problematic for it requires the use of optical or similar equipment to accurately determine the rebounding ball's height at the moment of zero velocity, the peak of its rebound.

Further, as no hard, dense surface is infinitely hard or dense, some loss will be encountered as the bouncing ball imparts some of its impact energy to the surface. Therefore, some sort of calculation method may be used to ensure accuracy in the measurements based on rebound height.

### SUMMARY

In accordance with embodiments of the present invention, a device for rebound testing of an object is provided. The device comprises: a substrate; a sensor coupled to the substrate for emitting a signal upon sensing impact of the object against the substrate; and a controller for receiving signals from the sensor, said controller being configured to measure a first time between a first signal from the sensor and a second signal from the sensor and to measure a second time between the second signal from the sensor and a third signal from the sensor.

In accordance with further embodiments of the present invention, a method of testing rebound qualities of an object, comprises: issuing a first signal in response to a first impact of the object onto a substrate; issuing a second signal in response to a second impact of the object onto the substrate; measuring a first time period between the first signal and the second signal; issuing a third signal in response to a third impact of the object onto the substrate; measuring a second time period between the second signal and the third signal.

In accordance with further embodiments of the present invention, a device for the measurement of golf ball rebound is provided. The device may include a substrate of hard and dense material, said substrate having a flat and level upper surface, said substrate attached to a sensor capable of sensing the impact a golf ball being manually dropped onto said substrate's upper surface and accordingly outputting a first sensor signal. The sensor may also be capable of sensing subsequent second and third impacts from said golf ball repeatedly bouncing against said substrate's upper surface causing said sensor to output a second and third sensor signal respectively. The sensor's output may be electrically connected to a microcontroller, said microcontroller including a clock source and a counter driven by said clock source, said microcontroller being programmed to reset said counter upon receipt of said sensor's first impulse signal. The microcontroller may be further programmed to, upon receipt of said sensor's second signal, read said counter value and store said value as a first numerical value and also reset said counter. The microcomputer may also be programmed to receive said third signal whereupon said microcontroller is programmed to read said counter and store said counter's numerical value as a second numerical value. The microcontroller may also be programmed to calculate a numerical result as the ratio of the square of said second numerical value to the square of said first numerical value, said numerical result being substantially proportional to the rebound value of the golf ball, and said numerical value being displayable as a number to the user. The numerical result can be scaled by a factor of 100 and displayed as a percentage value.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined solely by the claims attached hereto.

### BRIEF DESCRIPTION OF THE DRAWING

FIG. 1 is a side view of a rebound tester in accordance with embodiments of the present invention.

FIG. 2 is a front view of a rebound tester in accordance with embodiments of the present invention.

FIG. 3 is a top view of a rebound tester in accordance with embodiments of the present invention.

### DETAILED DESCRIPTION

In the following description, reference is made to the accompanying drawings which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense, and the scope of the embodiments of the present invention is defined only by the claims of the issued patent.

In accordance with embodiments of the present invention, a device is provided that can be used to determine the rebound value of a golf ball with high precision. In practice, a golf ball is dropped from a height of, for example, only a few inches, onto a massive, dense block or substrate. The ball is allowed to repeatedly bounce off the top surface of the substrate for at least three impacts. A sensor attached to the substrate senses the ball's impacts, and delivers impact timing information to a microprocessor, which in turn calculates the correct value of rebound.

The invention takes advantage of the laws of Newtonian Physics. In the case of a bouncing ball within a gravitational field, the ball has a maximum of potential energy and zero kinetic energy when it is at zero velocity and at its greatest height, and has a maximum of kinetic energy and zero potential energy at the moment it impacts the stationary surface. The direction of the ball's kinetic energy reverses as the ball impacts the stationary surface, and it is at this point where energy can be lost, due to non-idealities of the ball's constituent material. Energy is lost during rebound, as the ball's interaction with the surface is not perfectly elastic.

The energy required to lift the ball to a given height is equal to the mass of the ball times the distance it is lifted above the rebounding surface.

E=M*A*D (1)

Where:

E=Energy in Watt*Seconds

M=Mass in Kilograms

D=Distance in Meters

A=acceleration of gravity, 9.8 meters/second²

This is the energy invested in the ball as potential energy, when the ball is at its peak height and has zero velocity. Neglecting air friction losses, it is also equal to the ball's kinetic energy when the ball first strikes the rebounding surface, as at this point, the ball's velocity is at a maximum and its potential energy is zero.

The time for the ball to fall from zero velocity (rest) through a distance to a stationary striking surface is equal to the square root of the quantity twice the distance divided by the acceleration due to gravity:

T(fall)=(2*D/A)^{0.5} (2)

Where:

T(fall)=time (in seconds)

D=peak height of ball (in meters)

A=acceleration of gravity (9.8 meters/second squared)

Reciprocally, the time for a ball to rebound from a surface to a given height is exactly the same as that required for it to fall from that height back to the surface. This statement ignores frictional losses as the ball travels through the air; however, the air friction loss falls quickly as the peak velocity and peak rebound height diminish.

From the above, it can be found that the time between impacts is equal to:

T(period)=2*T(fall)=(4*D/A)^{0.5} (3)

Where:

T(period)=Time between impacts (in seconds)

And the peak kinetic energy in the ball during its flight is:

E=(M*A²*T(period)²)/4 (4)

Since the ball's mass is constant and the acceleration of gravity is constant, we can see from equation (4) that the energy of the rebounding ball is proportional to the square of the time between bounces.

In operation, a golf ball is dropped onto a surface and allowed to bounce. The surface can be, for example, the center of a massive, dense, flat substrate, and the ball can be allowed to bounce at least three times. The period of time between the first and second bounces is determined as the first period. The period of time between the second and third bounces is determined as the second period. Knowing that the energy invested in the ball during either period is proportional to that period squared, the proportion of energy lost can be determined, independent of the absolute energy values.

The ratio of the ball's energy after a rebound to the energy prior to the rebound can be calculated:

R=(T2²)(T1²) (5)

Where:

T1=the first period (in seconds)

T2=the second period (in seconds)

R=rebound value (0 to 1 in magnitude)

This resulting rebound value can be multiplied by 100 to obtain rebound as a percentage, or scaled to any other useful units for display.

The above discussion is only perfectly precise in the event that the loss due to air friction and the energy imparted to the measurement substrate during impact are both zero. Although these factors cannot be completely eliminated, they can be minimized through proper design.

In the case of air friction, the device could be operated in a complete vacuum, although in practice, this may be quite inconvenient. The solution to the air friction problem can be had by simply minimizing the peak velocity of the ball during the test and the time during which the ball experiences high velocities. This can be conveniently achieved by making the falling distance relatively short, on the order of a few inches.

The loss of bounce energy to the substrate can be minimized by making the substrate of an extremely hard material, as much as 100 times stiffer than that of the ball, so that it only minimally deforms upon impact, and also making the substrate as much as 100 times more massive than that of the ball under test. Although impractical, a 100 pound block of Iridium would be effective. Other materials of high hardness and mass could be used.

Finally, although some minimal amount of energy will be lost to the substrate on each impact, this can be anticipated and a slight correction factor can be introduced into each calculation to improve accuracy.

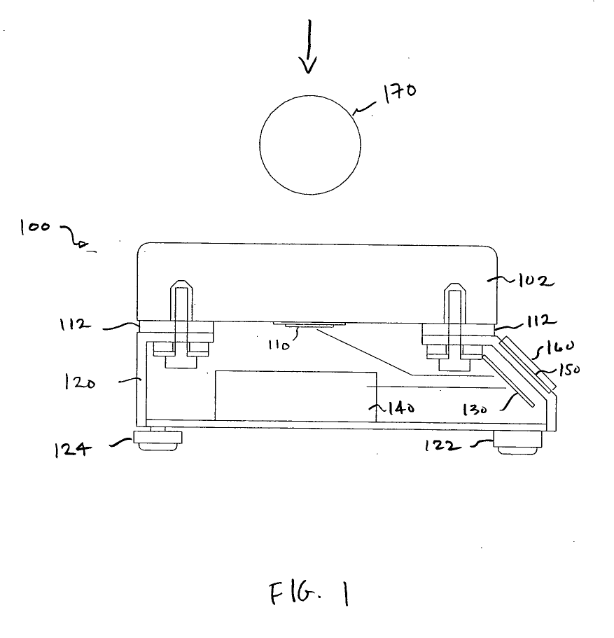

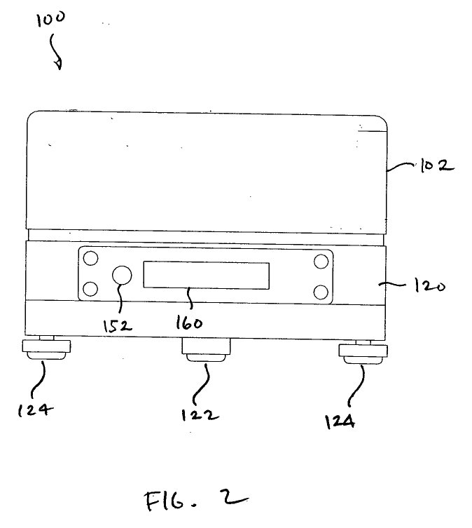

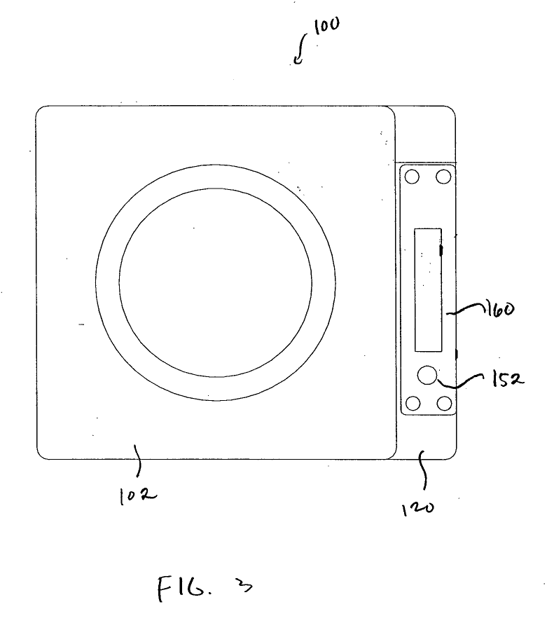

FIGS. 1-3 illustrate an embodiment of a rebound testing device 100 in accordance with embodiments of the present invention. FIG. 1 is a cross-sectional side view, FIG. 2 is a front view, and FIG. 3 is a top view. In these drawings, the rebound testing device includes a granite substrate 102, 9 inches square and 2 inches thick, polished on its upper, flat surface, and a sensor 110, such as a piezoelectric transducer, affixed to the center of the bottom surface of the substrate 102. The substrate 102 may be attached through a shock absorbing elastomer material 112 covering all but the center of its bottom surface to a cast metal case 120 which encloses the entirety of the processing module 130, power source 140, controls 150, and output display 160. The case 120 may be mounted to one or more feet 122 and/or one or more adjustable height feet 124, which can enable a user to level the upper surface of the substrate 102. The shape and material used for the substrate 102 can vary in other embodiments. In addition, material for the case 120 and the case's coupling to the substrate 102 can also vary.

In this embodiment, the piezoelectric sensor 110 is of the type used as a loudspeaker or buzzer in electronic equipment and toys. For example, the sensor 110 may be comprised of a disk of poled piezoelectric ceramic, approximately 20 millimeters in diameter and a few tenths of a millimeter thick, with silver electrodes fired onto both sides, adhesively attached to a 30 millimeter diameter brass disk of a few tenths of a millimeter in thickness. One electrical connection is made to the exposed silver electrode of the ceramic disk and a second connection is made to the brass disk. The brass side of the sensor 110 may be attached to the center of the bottom surface of the granite substrate 102 with epoxy resin.

The output of such a sensor 110 can be very accurate and effective. In the case of the above described assembly, a pulse output of several hundred millivolts results from the impact of a golf ball 170 onto the center of the top side of the granite substrate 102, when dropped from a modest height of 4 inches.

When the golf ball 170 strikes the upper surface of the granite substrate 102, the output signal from the sensor 110 is a single pulse of a polarity that is predetermined by the polarity of poling of the ceramic disk. This initial pulse is followed by a ringing signal, of much lower amplitude, due to the resonant characteristics of the granite, and the limited ability of the absorbing elastomer and cast case to dampen resonant energy from the substrate 102.

The sensor signal can then be processed by the processing module 130 as follows. The signal may be conducted to a Schmitt trigger circuit that produces an initial pulse, and perhaps several trailing pulses in rapid succession as the result of the substrate's resonance. Such trailing pulses are typically diminished to zero within approximately 20 milliseconds. The Schmitt trigger's output can be fed to, for example, an 8051 microcontroller, which has the ability through programming to start, stop, read and zero an internal counter that is driven by a constant clock frequency.

Upon receipt of the first pulse from the Schmitt trigger, as the result of a dropped golf ball first striking the granite substrate 102, the microcontroller software resets the counter and begins its counting. The microcontroller software can be configured to reject any further pulses from the Schmitt trigger for a period of, for example, at least 20 milliseconds, in order to eliminate the effects of the ringing signal. The microcontroller may then wait with counter running for the next pulse, the result of the ball striking the plate a second time. Upon receiving a second impact pulse, the microcomputer stores the first counter reading as a first period value, and resets the counter. Again, the software ignores the Schmitt trigger signal for approximately 20 milliseconds, and then awaits a third impact pulse. Upon receipt of the third pulse, the counter contents are read and stored as a second period. Throughout the process, the software can be designed to abort the timing process if the period between impacts ever exceeds a threshold maximum, such as, for example, 0.5 seconds. This would indicate a very high bounce, or more likely, the user terminating the test by catching the ball. A 0.5 second bounce period corresponds to a 12 inch bounce height.

Provided the microcontroller receives three pulses, none of which are more than 1 second apart (or greater than the threshold maximum), the two numbers are each squared numerically using the controller's internal math capability, and then the results of the two square operations are divided into each other to obtain a value ranging from a minimum of about 0.01 to a maximum of slightly less than 1 (for a free-bouncing ball with minimal energy lost). To this result is added a small constant to allow for the finite mass of the granite substrate 102 of, for example, about 0.01 to 0.05. The resulting value is multiplied by 100 and can be displayed as a percentage of rebound energy retained after each bounce. The display 160 can be, for example, a 3 digit LCD display.

The display 160 can also provide information to the user about the state of operation. For example, whenever the 0.5 second maximum count time is exceeded, or whenever 3 successive pulses are received and results are calculated and displayed, the device can revert back to a ready condition, ready to accept a new ball to be dropped onto the substrate 102. During this ready time, the LCD may display “READY” as an indication to the user of its ready state.

In the above-described embodiment, the user is expected to hold a golf ball approximately 3 to 6 inches above the center of the granite substrate 102 and drop the ball onto the substrate's surface. As the ball strikes the substrate 102, the unit's “READY” indication will go off, and the numeric display 160 can read “--.-”, or some other indicator of operational status. After the third successive impact of the golf ball against the granite surface, the display 160 will read “READY” and display the rebound, for example “78.3”.

In this embodiment, the processing module's electronics 130 may be completely battery powered by, for example, two AA size dry cells. A single power button 152, connected to the reset pin of the microcontroller can turn the unit on and off through software and the microcontroller's internal powerdown feature. Further, software within the microcontroller can be programmed to automatically power the system down if no impact has been detected for a predetermined shutdown time, such as, for example, 10 minutes. In this way, battery life can be significantly improved, and the device 100 can be used daily for years without battery replacement.

While the invention has been described in terms of particular embodiments, those of ordinary skill in the art will recognize that the invention is not limited to the embodiments or figures described. Numerous variations are possible. For example, while the discussion above relates to the use of a device for testing the rebound quality of a golf ball, it will be understood that other embodiments of the present invention could be used to test the rebound qualities of various objects, such as, for example, tennis balls, basketballs, etc.

In addition, in the above-described embodiment, a user can manually drop the golf ball onto the device's surface. In other embodiments, a loading mechanism can be provided. The golf ball may be loaded into the loading mechanism, and then the loading mechanism can drop the ball. This can ensure that the ball is dropped from a consistent height and is not provided with an initial acceleration by the user when being dropped. However, the use of such a loading mechanism is optional. In the above-described embodiment, variation in dropping height and initial acceleration may not have a substantial effect, if any, on the readout.

The figures provided are merely representational and may not be drawn to scale. Certain proportions thereof may be exaggerated, while others may be minimized. The FIGUREs are intended to illustrate various implementations of the invention that can be understood and appropriately carried out by those of ordinary skill in the art.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

1. A device for rebound testing of an object, comprising:
a substrate;
a sensor coupled to the substrate for emitting a signal upon sensing impact of the object against the substrate; and
a controller for receiving signals from the sensor, said controller being configured to measure a first time period between a first signal from the sensor and a second signal from the sensor and to measure a second time period between the second signal from the sensor and a third signal from the sensor.

2. The device of claim 1, wherein:
said controller is further configured to calculate a rebound value based on the first time period and the second time period.

3. The device of claim 2, wherein:
said controller is further configured to calculate the rebound value by calculating a ratio of the square of the first time period to the square of the second time period.

4. The device of claim 3, wherein:
said calculating the rebound value further comprises adding an offset constant to compensate for the mass of the substrate to the ratio of the square of the first time period to the square of the second time period.

5. The device of claim 2, further comprising:
a display coupled to the controller for displaying the rebound value.

6. The device of claim 1, wherein said controller comprises:
a clock source;
a counter driven by the clock source; and
a microcontroller configured such that:
upon receipt of the first signal, the microcontroller resets the counter;
upon receipt of the second signal, the microcontroller stores a first value of the counter as the first time period and resets the counter; and
upon receipt of the third signal, the microcontroller stores a second value of the counter as the second time period.

7. The device of claim 1, wherein:
said sensor comprises a piezoelectric transducer coupled to a bottom surface of the substrate.

8. A method of testing rebound qualities of an object, comprising:
issuing a first signal in response to a first impact of the object onto a substrate;
issuing a second signal in response to a second impact of the object onto the substrate;
measuring a first time period between the first signal and the second signal;
issuing a third signal in response to a third impact of the object onto the substrate;
measuring a second time period between the second signal and the third signal.

9. The method of claim 8, further comprising:
dropping the object onto a substrate to cause the first impact of the object onto the substrate.

10. The method of claim 8, wherein:
said issuing the first signal comprises issuing the first signal from a piezoelectric transducer coupled to a bottom surface of the substrate in response to the first impact of the object onto the substrate; and
said issuing the second signal comprises issuing the second signal from the piezoelectric transducer coupled to the bottom surface of the substrate in response to the second impact of the object onto the substrate.

11. The method of claim 8, further comprising:
calculating a rebound value based on the first time period and the second time period.

12. The method of claim 11, wherein:
said calculating the rebound value comprises calculating a ratio of the square of the first time period to the square of the second time period.

13. The method of claim 12, wherein:
said calculating the rebound value further comprises adding an offset constant to compensate for the mass of the substrate to the ratio of the square of the first time period to the square of the second time period.

14. The method of claim 11, further comprising:
displaying the rebound value.

15. The method of claim 11, wherein said measuring the first time period between the first signal and the second signal comprises:
upon receipt of the first signal, resetting a counter driven by a clock source; and
upon receipt of the second signal, storing a first value of the counter as the first time period.

16. The method of claim 15, wherein said measuring the second time period between the second signal and the third signal comprises:
upon receipt of the second signal, resetting the counter; and
upon receipt of the third signal, storing a second value of the counter as the second time period.

17. The method of claim 16, wherein said measuring the first time period between the first signal and the second signal comprises:
upon receipt of the first signal, disregarding additional signals for a predetermined time period.

18. The method of claim 16, further comprising:
aborting the testing process if an elapsed time between the first signal and the second signal or between the second signal and the third signal exceeds a predetermined threshold time.

19. The method of claim 18, wherein said predetermined threshold time comprises one second.

20. The method of claim 8, wherein said object is a golf ball.
